(19) United States
(12) Patent Application Publication
(10) Pub. No.: US 2008/0193067 A1
(43) Pub. Date: Aug. 14, 2008

(54) Tapered roller bearing for a planetary rotary member

(76) Inventors: Junichi Hattori, Kuwana (JP); Michio Hori, Kuwana (JP); Eiichi Nakamizo, Kuwana (JP); Tsukasa Toyoda, Kuwana (JP)

Correspondence Address: WENDEROTH, LIND & PONACK, L.L.P., 2033 K STREET N. W., SUITE 800, WASHINGTON, DC, 20006-1021, US

(21) Appl. No.: 12/010,633

(22) Filed: Jan. 28, 2008

(30) Foreign Application Priority Data
Feb. 13, 2007 (JP) 2007-32087

(51) Int. Cl. F16C 33/36

(52) U.S. Cl. 384/128

(57) ABSTRACT

A tapered roller bearing is proposed for supporting each of planetary rotary members that rotate about a common axis and their own axes. The tapered roller bearing includes an inner ring spacer provided adjacent to the small-diameter flange of the inner ring. The retainer retaining the tapered rollers in position includes small- and large-diameter annular portions and bridges connecting the two annular portions together. The retainer further includes a disk portion extending radially inwardly from the axially outer end of the small-diameter annular portion, and a third annular portion extending axially outwardly from the radially inner end of the disk portion. The third annular portion has a radially inner guided surface guided by the radially outer guiding surface of the inner ring spacer. A hardened surface layer and a lubricating film are formed on the radially outer guiding surface of the inner ring spacer.

### BACKGROUND OF THE INVENTION

This invention relates to a tapered roller bearing for rotatably supporting one of a plurality of planetary rotary members that rotate about a common axis and also about their own axes.

Many of tapered roller bearings, in which a plurality of tapered rollers are arranged circumferentially between raceways of inner and outer rings, include a conical retainer comprising small- and large-diameter annular portions facing the small- and large-diameter end surfaces of the tapered rollers, respectively, and a plurality of bridges that connect the small- and large-diameter annular portions together, and defining pockets between the adjacent bridges in which the respective tapered rollers are received. Another type of known tapered roller bearings include a comb-shaped retainer having no small-diameter annular portion and having its bridges connected together by the large-diameter annular portion only like comb teeth.

Such retainers are formed by pressing a metal plate such as a steel plate, or by machining a metal material such as steel or brass. Many of such retainers have their bridges, which define the roller pockets, guided by the tapered rollers. Another type of retainers include bent protrusions extending from the small-diameter annular portion and supported by the raceway of the inner ring, the outer periphery of the small-diameter flange of the inner ring, or the raceway of the outer ring (as disclosed e.g. in JP patent publication 2004-293730A).

On the other hand, planetary speed reducers are known which can achieve a large speed reduction ratio. Typical such planetary speed reducers are planetary gear speed reducers. Planetary gear speed reducers comprise a sun gear mounted on an input shaft, an internal gear fixed e.g. to a housing, a carrier having pins each rotatably supporting one of a plurality of planetary gears disposed between the sun gear and the internal gear. When the planetary gears are rotated about the axis of the sun gear and their own axes, their rotation about the axis of the sun gear is transmitted to an output shaft (as disclosed in JP patent publication 07-103320A). Planetary roller speed reducers are also known in which the sun gear, internal gear and planetary gears of the above planetary gear speed reducers are all replaced by rollers (as disclosed in JP patent publication 08-130853A).

In many of small-sized such planetary speed reducers, their planetary gears or rollers are supported by needle bearings, whereas in many of medium- to large-sized such planetary speed reducers, their planetary gears or rollers are supported by tapered roller bearings, self-aligning roller bearings or cylindrical roller bearings.

To the retainer of a tapered roller bearing supporting each of the planetary rotary members (planetary gears or rollers) of a planetary speed reducer, which rotate about their common axis as well as about their own axes, in addition to the centrifugal force due to rotation of the planetary rotary member about its own axis, the centrifugal force due to rotation of the planetary rotary member about the common axis is also applied. The centrifugal force due to rotation of the planetary rotary member about the common axis tends to move the retainer so as to be offset from the center of the bearing. Thus, as the centrifugal force due to rotation about the common axis increases with an increase in the rotational speed about the common axis, if the retainer is of the type in which its bridges are guided by the tapered rollers, because the retainer is offset from the bearing center, some bridges are pressed hard against the tapered rollers, so that these bridges may be abraded severely, or may be destroyed due to concentration of bending moment on their portions connected to the annular portions.

With the type in which the retainer is guided by a bearing ring as disclosed in JP patent publication 2004-293730, while the bridges are not abraded or destroyed, because the bent protrusions extending from the small-diameter annular portion have guided surfaces at their free ends which are guided by the raceway of the inner ring, the outer periphery of the small-diameter flange of the inner ring, or the raceway of the outer ring, the contact area between the guided surfaces and the guiding surface on one of the bearing rings is small, so that the contact surface pressure is high. This increases the possibility of wear and seizure at the guiding and guided surfaces. One way to prevent such wear and seizure at the guiding and guided surfaces would be to improve the material or the properties of guiding surface on one of the bearing rings so as to reduce the frictional resistance between the guiding and guided surfaces. But because the material of the bearing rings, i.e. inner and outer rings has to be selected taking preferentially and primarily into consideration their rolling fatigue life, it is difficult to improve the material or the properties of the guiding surface so as to improve the frictional resistance between the guiding and guided surfaces.

Also, if the raceway of the inner or outer ring is used as the guiding surface, because the protrusions have to be inserted between the tapered rollers, the guided surfaces of the protrusions are present only at portions of the entire circumference, so that the contact area of the guided surfaces tends to be relatively small. Also, because the raceways of the inner and outer rings are axially inclined, axial component forces act on the guided surfaces of the retainer, so that the inner end surface of one of the annular portions defining the roller pockets tends to be pressed against the end surfaces of the tapered rollers. If the inner end surface of one of the annular portions is pressed against the end surfaces of the tapered rollers, torque loss of the bearing increases.

An object of the present invention is to provide a tapered roller bearing for supporting one of planetary rotary members that rotate about a common axis and their own axes in which it is possible to prevent wear and seizure between a guided surface of the retainer and the guiding surface.

### SUMMARY OF THE INVENTION

In order to achieve this object, the present invention provides a tapered roller bearing for rotatably supporting a planetary rotary member having a central axis and rotatable about the central axis and about an axis other than the central axis, the tapered roller bearing comprising an inner ring having a first raceway, an outer ring having a second raceway, a plurality of tapered rollers disposed between the first and second raceways, a retainer retaining the tapered rollers in position, and one of an inner ring spacer keeping the inner ring in position and an outer ring spacer keeping the outer ring in position, the retainer having a guided portion having a guided surface extending the entire circumference thereof and guided by the one of the inner ring spacer and the outer ring spacer.

With this arrangement, it is possible to ensure a sufficiently large contact area between the guided surface on the retainer and the guiding surface on the inner ring spacer or the outer ring spacer, thereby reducing the contact surface pressure therebetween. Because the guiding surface is formed on the spacer, for which it is not necessary to ensure a rolling fatigue life as with the bearing rings, it is possible to readily improve the material and properties of the guiding surface so as to reduce e.g. the frictional resistance between the guiding and guided surfaces. This in turn makes it possible to prevent wear and seizure between the guided surface of the retainer and the guiding surface. Further, since the guiding surface formed on the inner or outer ring spacer is not axially inclined, no axial component forces act on the guided surface of the retainer, so that the inner end surfaces of the annular portions defining the roller pockets would not be pressed against the end surfaces of the tapered rollers.

By forming a hardened surface layer on the guiding surface of the inner or outer ring spacer that guides the guided surface of the retainer, the wear resistance of the guiding surface improves. The hardened surface layer may be formed by carbonitriding.

By forming a lubricating film on the guiding surface of the inner or outer ring spacer that guides the guided surface of the retainer, the frictional resistance of the guiding surface decreases. The lubricating film may be formed by phosphate film treatment.

By annularly shaping the guided portion of the retainer, it is possible to further increase the contact area between the guided surface and the guiding surface.

By forming the retainer from steel and forming a hardened surface layer on the guided surface of the guided portion, the wear resistance of the guided surface improves. The hardened surface layer may be formed by Tufftride treatment or by partial hardening.

By forming the retainer from a resin, the frictional resistance decreases. Such resins include polyamide resins such as nylon, fluororesins such as polytetrafluoroethylene, polyetherketone resins such as polyetheretherketone, polyamideimide resins, polyimide resins, polyphenylene sulfide resins, and a mixture thereof. If necessary, to the resin may be added fibrous reinforcing materials such as carbon fiber and glass fiber, flaky reinforcing materials such as mica and talc, microfiber reinforcing materials such as potassium titanate whiskers, solid lubricants such as polytetrafluoroethylene, graphite and molybdenum disulfide, and sliding reinforcing materials such as calcium phosphate and calcium sulfate.

By forming the retainer from high-strength brass too, it is possible to reduce the frictional resistance of the guided surface.

The present invention also provided an assembly for rotatably supporting a planetary rotary member having a central axis and rotatable about the central axis and about an axis other than the central axis, the assembly comprising a pair of tapered roller bearings combined in a back-to-back arrangement, and each comprising an inner ring having a first raceway, an outer ring having a second raceway, a plurality of tapered rollers disposed between the first and second raceways, and a retainer retaining the tapered rollers in position, and an outer ring spacer disposed between the outer rings of the pair of tapered roller bearings, the retainer of each of the tapered roller bearings having a guided portion having a guided surface extending the entire circumference thereof and guided by the outer ring spacer.

The tapered roller bearing according to the invention can be most advantageously used to support a planetary rotary member in the form of a planetary gear or a planetary roller in a planetary speed reducer.

### BRIEF DESCRIPTION OF THE DRAWINGS

Other features and objects of the present invention will become apparent from the following description made with reference to the accompanying drawings, in which:

FIG. 1 is a vertical sectional view of a tapered roller bearing for a planetary rotary member according to a first embodiment of the invention;

FIG. 2 is a vertical sectional view of a tapered roller bearing with a modified retainer;

FIG. 3 is a vertical sectional view of a planetary gear speed reducer including tapered roller bearings of FIG. 1;

FIG. 4 is a sectional view taken along line IV-IV of FIG. 3;

FIG. 5 is a vertical sectional view of a tapered roller bearing for a planetary rotary member according to a second embodiment of the invention;

FIG. 6 is a vertical sectional view of tapered roller bearings for a planetary rotary member according to a third embodiment of the invention; and

FIG. 7 is a vertical sectional view of tapered roller bearings for a planetary rotary member according to a fourth embodiment of the invention.

### DETAILED DESCRIPTION OF THE PREFERRED EMBODIMENTS

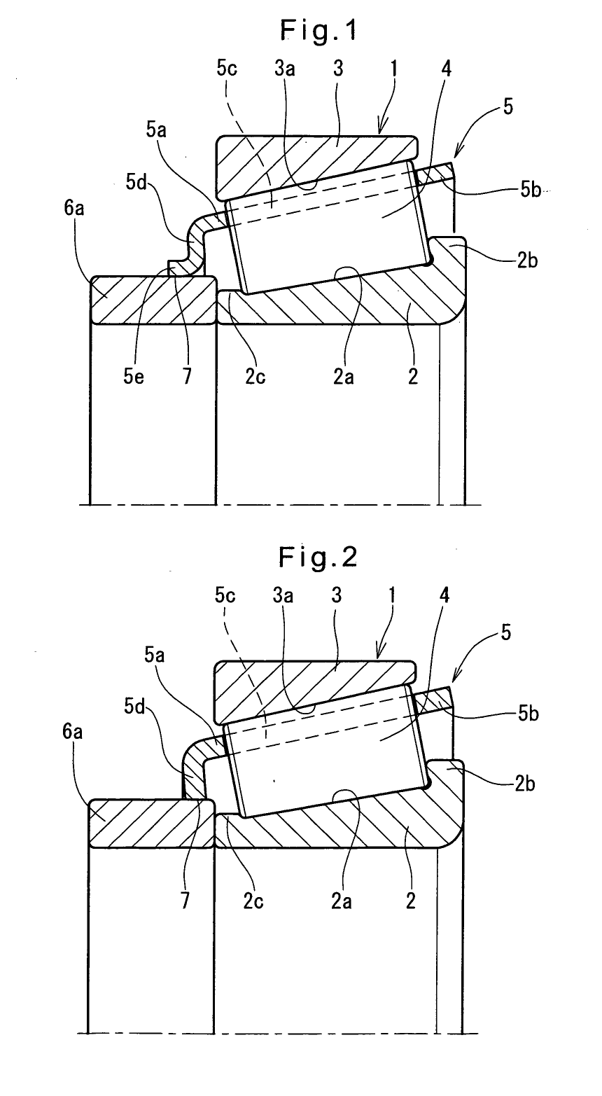

Now referring to the drawings, the embodiments of the present invention are described. FIG. 1 shows a tapered roller bearing 1 for a planetary rotary member according to the first embodiment. This bearing comprises an inner ring 2 having a raceway 2a, an outer ring 3 having a raceway 3a, a plurality of tapered rollers 4 disposed between the raceways 2a and 3a, and a conical retainer 5 comprising a small-diameter annular portion 5a that opposes the small-diameter end surfaces of the rollers 4, a large-diameter annular portion 5b that opposes the large-diameter end surfaces of the rollers 4, and a plurality of bridges 5c through which the small- and large-diameter annular portions 5a and 5b are coupled together. The inner ring 2 has large- and small-diameter flanges 2b and 2c at the respective ends of the raceway 2. An inner ring spacer 6a is provided adjacent to the small-diameter flange 2c of the inner ring 2.

The conical retainer 5 is formed by pressing a steel plate, and includes a disk portion 5d extending radially inwardly from the outer end of the small-diameter annular portion 5a, and an annular portion 5e axially outwardly extending from the radially inner end of the disk portion 5d so as to form a right angle with the disk portion 5d. The annular portion 5e is guided by the radially outer surface of the inner ring spacer 6a. Specifically, the annular portion 5e has a radially inner guided surface 7 which is guided by the radially outer surface of the inner ring spacer 6a, which serves as a guiding surface. On this radially outer guiding surface of the inner ring spacer 6a, a hardened surface layer is formed by carbonitriding, and further a lubricating film is formed by phosphate film forming treatment. On the guided surface 7, a hardened surface layer is formed by Tufftride treatment.

FIG. 2 shows a modified retainer 5. This retainer 5 has no annular portion 5e, and the radially inner end surface of the disk portion 5d serves as the guided surface 7 guided by the radially outer surface of the inner ring spacer 6a.

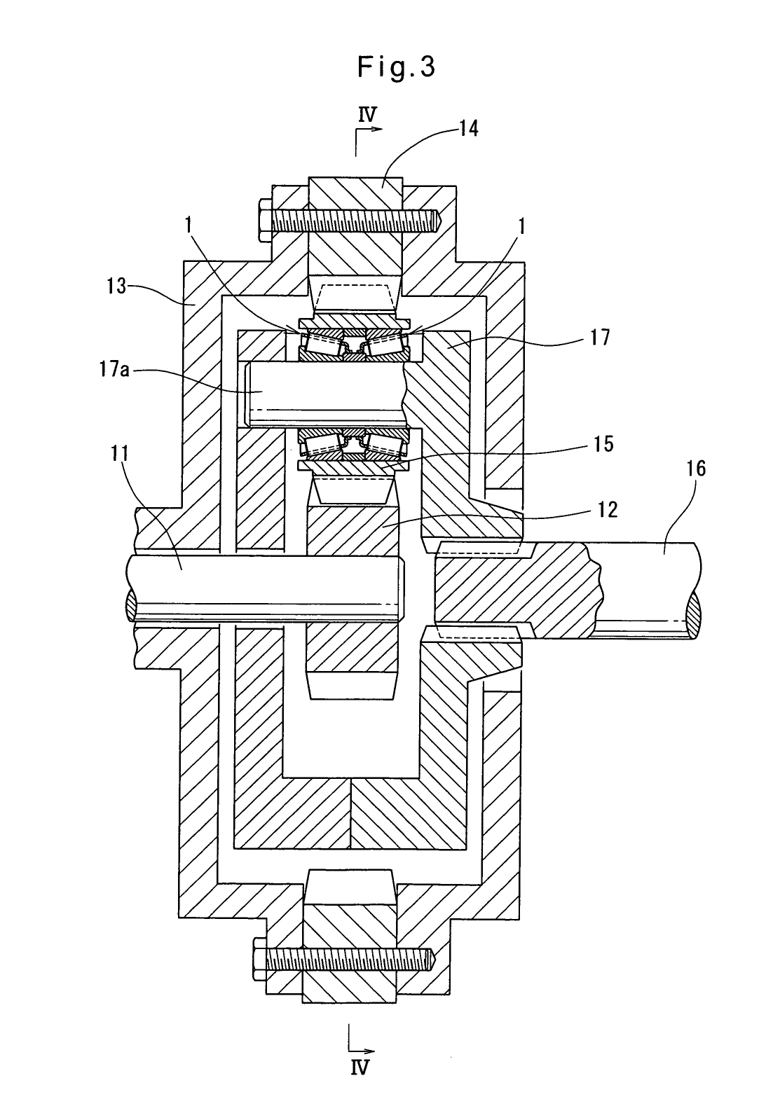

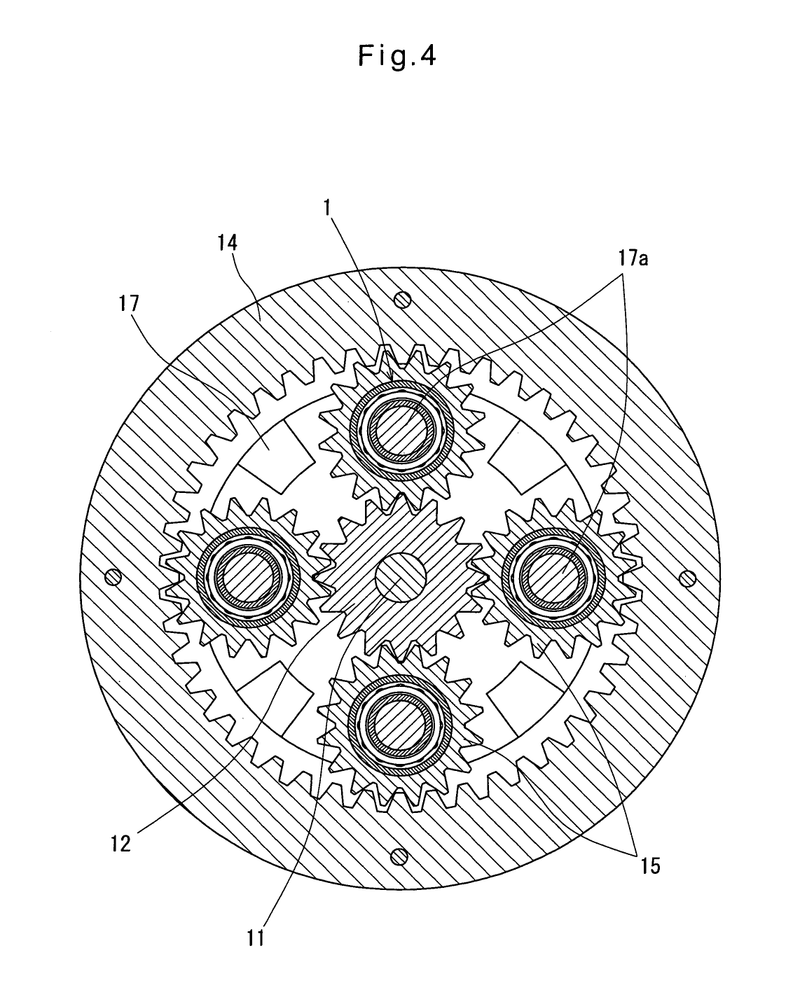

FIGS. 3 and 4 show a planetary gear speed reducer including planetary gears as planetary rotary members supported by the above-described type of tapered roller bearings 1. This planetary gear speed reducer comprises a sun gear 12, an internal gear 14 fixed to a housing 13, and the plurality of planetary gears 15, which are provided between and meshing with the sun gear 12 and the internal gear 14. Each planetary gear 15 is rotatably supported, through a pair of the tapered roller bearings 1 which are combined in a back-to-back arrangement, on one of a plurality pins 17a of a carrier 17 coupled to an output shaft 16. Thus, when the planetary gears 15 rotate about the axis of the sun gear while simultaneously rotating about their own axes, their rotation about the axis of the sun gear is transmitted to the output shaft 16 through the carrier 17.

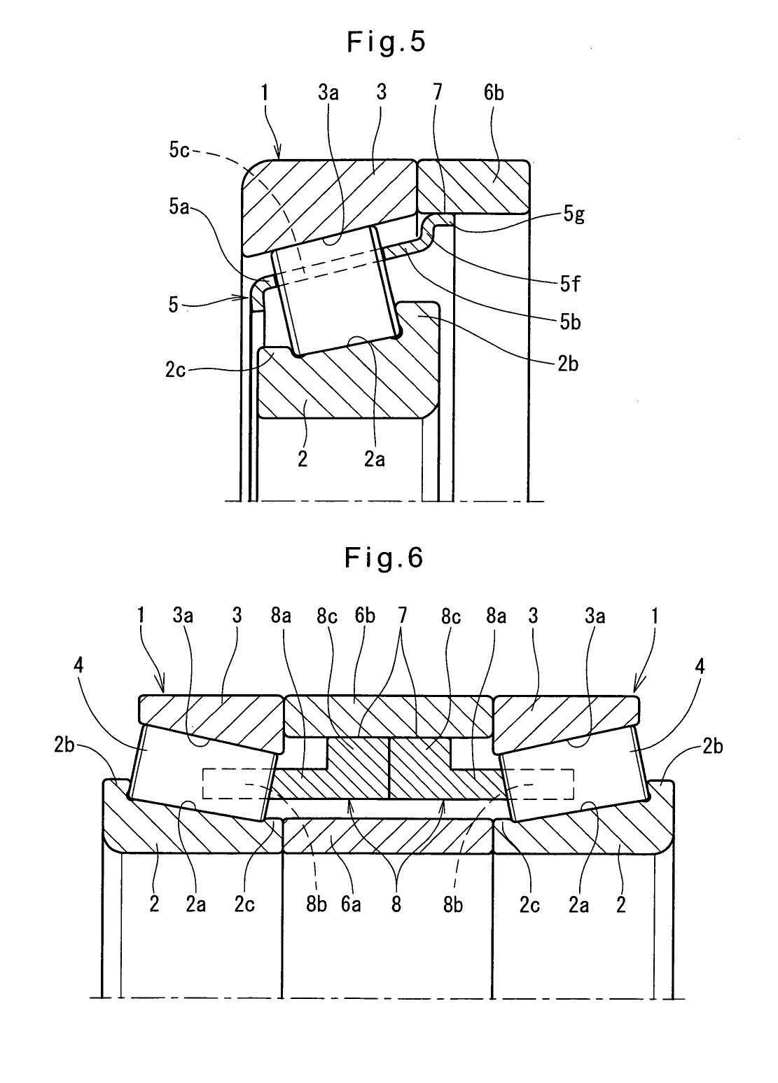

FIG. 5 shows a tapered roller bearing 1 for a planetary rotary member according to the second embodiment. The second embodiment differs from the first embodiment in that instead of the inner ring spacer 6a, an outer ring spacer 6b is provided at the large-diameter end of the raceway 3a of the outer ring 3, that the conical retainer 5 is formed by injection-molding a nylon resin, that instead of the disk portion 5d and the annular portion 5e, the retainer 5 includes a disk portion 5f extending radially outwardly from the outer end of the large-diameter annular portion 5b, and an annular portion 5g axially outwardly extending from the radially outer end of the disk portion 5f so as to form a right angle with the disk portion 5f. The annular portion 5g is guided by the radially inner surface of the outer ring spacer 6b. Specifically, the annular portion 5g has a radially outer guided surface 7 which is guided by the radially inner surface of the outer ring spacer 6b, which serves as a guiding surface. Otherwise, this embodiment is structurally identical to the first embodiment.

FIG. 6 shows a pair of tapered roller bearings 1 for a planetary rotary member according to the third embodiment of the invention. The pair of bearings 1 are combined in a back-to-back arrangement, and each include an inner ring 2, an outer ring 3, and tapered rollers 4 disposed between the inner and outer rings 2 and 3. An inner ring spacer 6a and an outer ring spacer 6b are disposed between the inner rings 2 and between the outer rings 3, respectively. The tapered rollers 4 of each tapered roller bearing 1 are retained in position by a comb-shaped retainer 8 comprising a plurality of comb tooth-shaped bridges 8b and an annular portion 8a facing the small-diameter end surfaces of the tapered rollers 4 and coupling the bridges 8b together.

The comb-shaped retainer 8 is formed by machining high-strength brass, and includes an annular rib 8c extending radially outwardly from the annular portion 8a and having a radially outer guided surface 7 guided by the radially inner surface of the outer ring spacer 6b. On the radially inner (guiding) surface of the outer ring spacer 6b, as in the first embodiment, a hardened surface layer is formed by carbonitriding, and further a lubricating film is formed by phosphate film forming treatment.

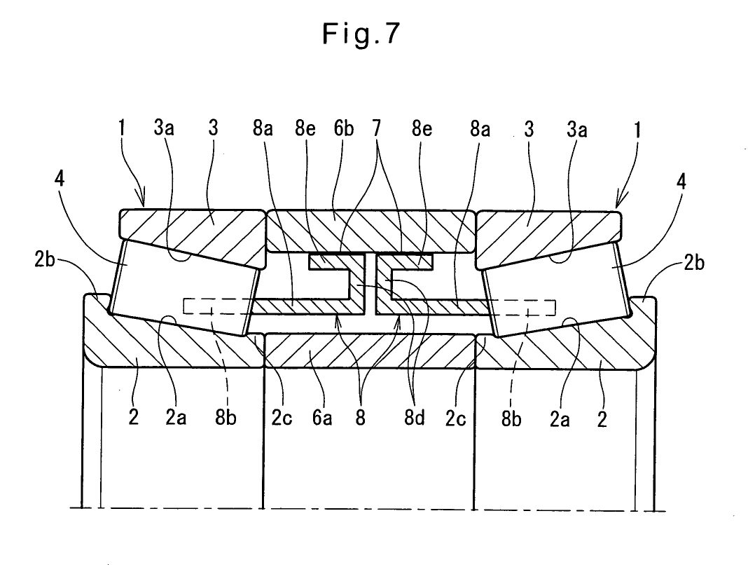

FIG. 7 shows a pair of tapered roller bearings 1 for a planetary rotary member according to the fourth embodiment of the invention. This embodiment is basically of the same structure as the third embodiment, but differs therefrom in that the comb-shaped retainers 8 are formed by pressing a steel plate, and each include a disk portion 8d extending radially outwardly from the axially outer end of the annular portion 8a, and an annular portion 8e extending axially inwardly from the radially outer end of the disk portion 8d to form a right angle with the disk portion 8d. The annular portion 8e has a radially outer guided surface 7 guided by the radially inner surface of outer ring spacer 6b. On the guided surface 7, a hardened surface layer is formed by Tufftride treatment. Otherwise, this embodiment is identical to the third embodiment.

In the embodiment of FIGS. 3 and 4, planetary gears of a planetary gear speed reducer are supported by the tapered roller bearings according to the present invention. But the tapered roller bearing according to the present invention can also be used to support a planetary roller in a planetary roller speed reducer, or any other planetary rotary member that rotates about its own axis and simultaneously about another axis parallel to its own axis.

What is claimed is:

1. A tapered roller bearing for rotatably supporting a planetary rotary member having a central axis and rotatable about the central axis and about an axis other than the central axis, said tapered roller bearing comprising an inner ring having a first raceway, an outer ring having a second raceway, a plurality of tapered rollers disposed between said first and second raceways, a retainer retaining said tapered rollers in position, and one of an inner ring spacer keeping said inner ring in position and an outer ring spacer keeping said outer ring in position, said retainer having a guided portion having a guided surface extending the entire circumference thereof and guided by said one of said inner ring spacer and said outer ring spacer.

2. The tapered roller bearing of claim 1 wherein said guided surface of said guided portion of said retainer is guided by a guiding surface formed on said one of said inner ring spacer and said outer ring spacer, and wherein a hardened surface layer is formed on said guiding surface.

3. The tapered roller bearing of claim 1 wherein said guided surface of said guided portion of said retainer is guided by a guiding surface formed on said one of said inner ring spacer and said outer ring spacer, and wherein a lubricating film is formed on said guiding surface.

4. The tapered roller bearing of claim 1 wherein said guided portion of said retainer is annularly shaped.

5. The tapered roller bearing of claim 1 wherein said retainer is made of steel, and wherein a hardened surface layer is formed on said guided surface of said guided portion.

6. The tapered roller bearing of claim 1 wherein said retainer is made of a resin.

7. The tapered roller bearing of claim 1 wherein said retainer is made of high-strength brass.

8. An assembly for rotatably supporting a planetary rotary member having a central axis and rotatable about the central axis and about an axis other than the central axis, said assembly comprising:
a pair of tapered roller bearings combined in a back-to-back arrangement, and each comprising an inner ring having a first raceway, an outer ring having a second raceway, a plurality of tapered rollers disposed between said first and second raceways, and a retainer retaining said tapered rollers in position; and
an outer ring spacer disposed between said outer rings of said pair of tapered roller bearings;
said retainer of each of said tapered roller bearings having a guided portion having a guided surface extending the entire circumference thereof and guided by said outer ring spacer.

9. The tapered roller bearing of claim 1 wherein said planetary rotary member is a planetary gear or a planetary roller in a planetary speed reducer.
